(19) United States
(12) Patent Application Publication
(10) Pub. No.: US 2009/0173154 A1
(43) Pub. Date: Jul. 9, 2009

(54) Device for fastening a sensor to a support part

(76) Inventors: Uwe Spitz, Rheinfelden (DE); Christoph Jürgens, Schallbach (DE); Mathias Hänsel, Rümmingen (DE); Laurent Chouvet, Neuenburg (DE)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 11/920,662

(22) PCT Filed: Apr. 13, 2006
(86) PCT No.: PCT/EP2006/003407

§ 371 Date: Jan. 23, 2009

(30) Foreign Application Priority Data
May 20, 2005 (DE) 10 2005 023 221.3

(51) Int. Cl. G01D 11/24

(52) U.S. Cl. 73/431

(57) ABSTRACT

A device for fastening a sensor to a support part comprises a sensor mount (1). The sensor mount (1) is made of sheet metal and comprises a base plate (2) as well as a counter plate (5), which is placed at a distance from the base plate (2) while being joined thereto. The area of the base plate (2) is greater than the area of the counter plate (5). Indexing means (18, 19, 20) are formed on the counter plate (5) in order to ensure, together with counter means formed on the sensor, the insertion of the sensor into the sensor mount (1) at a correct angle. This device is characterized, with a precise pre-alignment of the sensor, by having a particularly low weight.

The invention now relates to a sensor mount in accordance with the introductory clause of patent claim 1.

A sensor mount of this type is known from EP 1 005 692 B1. The previously known sensor mount for fastening a sensor to a support part has a counter-plate that surrounds the sensor. Formed onto the counter-plate is a receiving socket for the sensor, which is produced from sheet metal and equipped with indexing means that interact with the counter-means formed on the sensor for insertion of the sensor into the sensor mount at a correct angle. The counter-plate is formed with recesses into which plug-in tongues, formed on a base plate as an additional part of the sensor mount, can be inserted in order to connect the counter-plate with the base plate that is molded on the support part. The base plate is made ring-shaped, and exhibits an area that is relatively small when compared with the counter-plate.

DE 103 47 098 A1 discloses a sensor arrangement for a motor vehicle, having in a flat-shaped element a receiving arrangement for a sensor. The receiving arrangement is formed with a holder that is designed with a dome-shaped foot part that protrudes outward and surrounds a sensor head. Formed on the side of the foot part that faces away from the flat-shaped element is a clamping arrangement that fixes in place a sensor head of the sensor.

EP 1 312 521 A2 discloses a device for fastening a sensor, built up from several individual elements, on a support part having a pot-like base part that holds a number of optical elements of the sensor. Placed on webs formed on the base part is a printed circuit board to which the electrical elements of the sensor are connected. The printed circuit board is fixed in place by means of a cover part that can be locked with the base part.

DE 100 60 447 B4 discloses a resilient retaining tongue, which, as a separate part, spans a sensor in order to fasten it, and is attached at both ends to the sensor mount.

Known from DE 198 04 165 A1 is a device in which a ring-like sensor mount that surrounds the sensor and is made of a solid material, a plastic material in particular, is present. The sensor mount is equipped with indexing means which, in the generic device, are formed by a recess that interrupts, in the radial direction, the sensor mount in its basic ring-like structure. A slot-like prolongation of a holding cage of the sensor can be inserted into the recess as a counter-means so that the sensor is arranged at a correct angle in the sensor mount.

The invention is based on the problem of suggesting a sensor mount of the type described above that is characterized by a design that is simple, saves on material and has a compact and rugged design, and ensures reliable fastening of the sensor mount to a support part, particularly by means of bonding.

According to the invention, this problem is solved with a sensor mount of the type mentioned above and having the characterizing features of patent claim 1.

Through the fact that the sensor mount is formed in one piece with a base plate that is connected with the counter-plate by means of a side wall and exhibits a relatively large area, and the fact that the indexing means are formed on the counter-plate, a flat design is obtained that has a relatively large fastening area for joining with the support part. In conjunction with that, the basic shape of the sensor mount can be produced by means of a relatively simple punch-bend operation. Through the forming of an additional side wall between the base plate and the counter-plate, as well as the provision on the other side wall and on the counter-plate of locking structures that can be brought into engagement, a very rugged sensor mount design results.

Additional useful developments of the device according to the invention are the objects of the subclaims.

In the following, the device according to the invention is explained in more detail with the aid of references to an embodiment.

The following are shown:

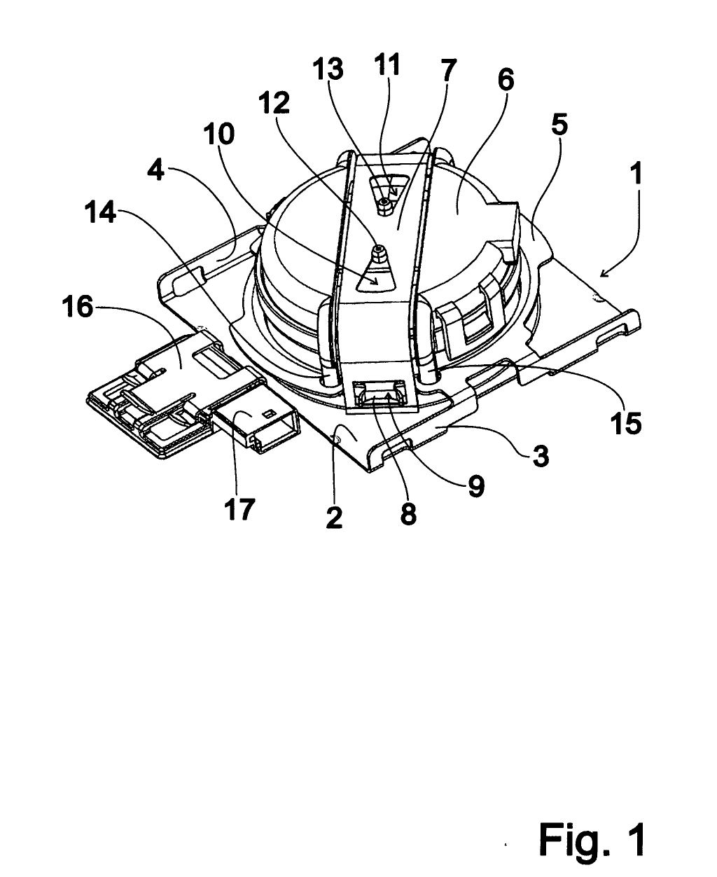

FIG. 1 A perspective view of an embodiment of a device according to the invention, with a rain sensor and a condensation sensor,

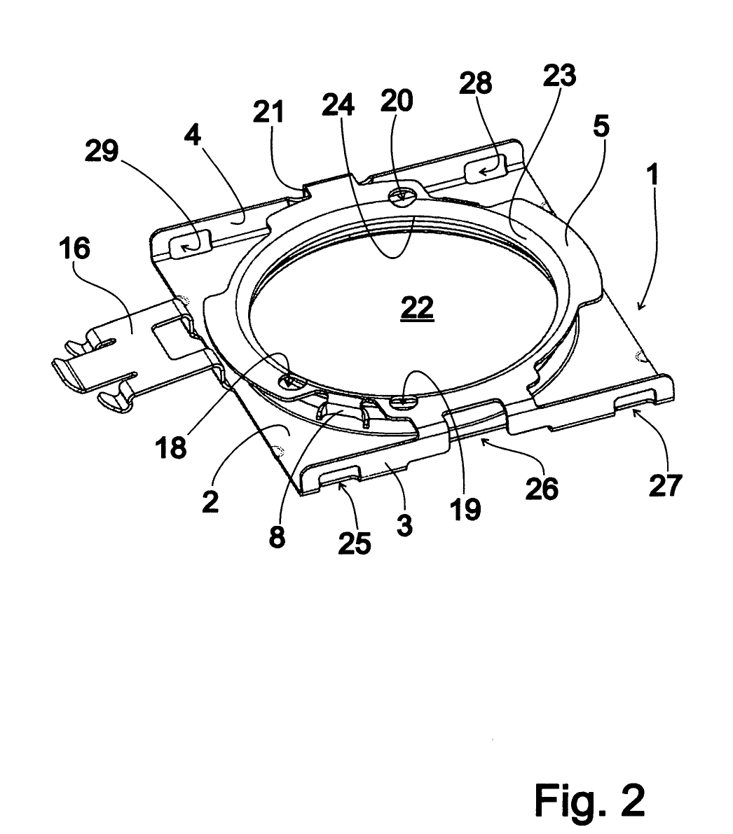

FIG. 2 A perspective view of the embodiment according to FIG. 1 without the sensors and

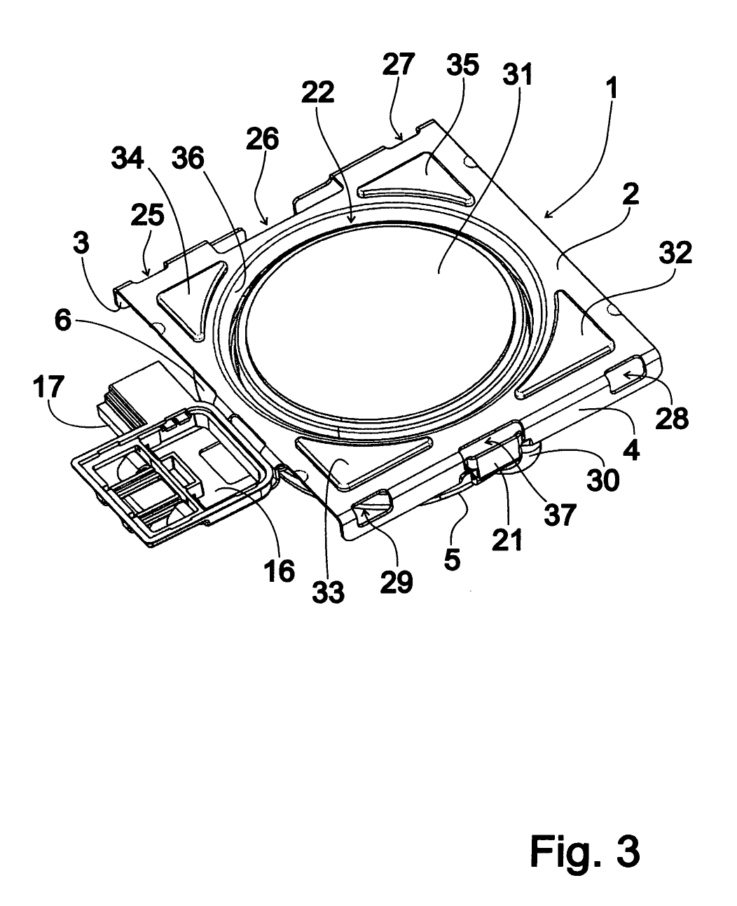

FIG. 3 A perspective view of the embodiment according to FIG. 1 with a viewing direction that is opposite the viewing direction of FIG. 1.

FIG. 1 shows a perspective view of an embodiment of a device according to the invention, with a sensor mount 1 which, in the embodiment shown, is produced from a piece of sheet metal that has been punched and then subjected to a series of bending operations. The sensor mount 1 comprises a base plate 2 that is rectangular, preferably essentially square, in its external dimensions, on which a first side wall 3 and a second side wall 4 are formed, which stand up essentially at a right angle to the base plate 2, both pointing in the same direction. In addition, the sensor mount 1 is equipped with a counter-plate, which, in the embodiment shown, is configured in the shape of a receiving ring 5, which is arranged at a distance from the base plate 2 and is connected with the first side wall 3 by means of a one-piece connecting part and with the second side wall 4 by means of another, detachable, connector that is explained in more detail below.

In the illustration according to FIG. 1, the sensor mount 1 surrounds a roundish rain sensor 6, which is held to the sensor mount 1 by means of a U-shaped retaining strap 7. In the embodiment according to FIG. 1, present in the region at each of the two ends of the retaining strap 7 is a locking structure, which in each case is comprised of a latching tongue 8 formed onto the receiving ring 5, and a latching recess 9 made in each end region of the retaining strap 7. In the region lying between its legs, the retaining strap 7 also has fixing recesses 10, 11, through which fixing pins 12, 13, which lie on the top of the rain sensor 6 in the visible region illustrated in FIG. 1, engage and lie against the fixing recess 10, 11 ends that point towards one another.

It can also be seen from FIG. 1 that the rain sensor 6 exhibits a number of aligning pins, whereby the aligning pins 14, 15 that are visible in the illustration according to FIG. 1 are arranged on both sides of the retaining strap 7 and extend in the direction of the receiving ring 5.

It can also be seen from FIG. 1 that affixed on the base plate 2 in the illustrated embodiment is a retaining tongue 16, which has resilience with a certain prestress force in accordance with the material selection, and by means of which an additional sensor, a condensation sensor 17, can be mounted in detachable fashion. The retaining tongue 16 is connected with the base plate 2 as one piece, and is positioned for the purpose of pressing the condensation sensor 17 against a support part, not shown in FIG. 1, with a predetermined force.

FIG. 2 shows a perspective view of the embodiment according to FIG. 1 without the rain sensor 7, the retaining strap 7 and the condensation sensor 17. It can be seen from FIG. 2 that aligning recesses 18, 19, 20, into which the associated aligning pins engage with proper arrangement of the rain sensor 6, are brought into the receiving ring 5 at the positions of the aligning pins 14, 15, which are visible in the illustration according to FIG. 1, and at the position of an additional aligning pin, not visible in the illustration according to FIG. 1, of the rain sensor 6. The aligning recesses 18, 19, 20 are arranged in such a way that the angular distances between at least two aligning recesses 18, 19, 20 are different, so that the aligning recesses 18, 19, 20 form indexing means in order to ensure an insertion of the rain sensor 6 into the sensor mount 1 at the correct angle. As a result, an encoding for various types of sensors, rain sensors 6 in particular, is created as well.

It can additionally be seen from FIG. 2 that formed onto the receiving ring 5 in the connecting region on the side opposite the first side wall 3 is a locking tongue 21, which is aligned essentially at a right angle to the plane of the receiving ring 5 and, in the arrangement according to FIG. 2, extends in the direction of the base plate 2 and engages behind the second side wall 4 on the side opposite the base plate 2.

It can also be seen clearly in FIG. 2 that configured on the inside of the receiving ring 5 facing a sensor channel 22 that receives the rain sensor 6 is a chamfer 23, which points in the direction of the base plate 2 and stiffens the receiving ring 5 in terms of bending stresses. Placed on the chamfer 23 is a cylindrical collar 24, which extends in the direction of the base plate 2 and brings about the exact positioning of the rain sensor 6.

It can additionally be seen from FIG. 2 that brought into the transition region from the base plate 2 to the side walls 3, 4 are edge recesses 25, 26, 27, 28, 29, into which engaging means, not shown in FIG. 2, can engage in order to arrange the sensor mount 1 on a support part, not shown in FIG. 2, and after such fastening to the support part, can engage on latching elements of a cover part, also not shown in FIG. 2.

FIG. 3 shows a perspective view of the embodiment according to FIG. 1 and FIG. 2, on a side away from the viewing direction in FIG. 1, looking at the sensor mount 1 with inserted rain sensor 6. It should first be noted in connection with the rain sensor 6 that in the illustration according to FIG. 3, alignment pin 30, which engages in the aligning recess 20 arranged in the region of the locking tongue 21, is visible. It can also be seen from FIG. 3 that a silicone layer 31 has been applied to the rain sensor 6.

Mounted adjacent to the sensor channel 22 on the side of the base plate 2 opposite the receiving ring 5 are a number of hot-melt bonding pads 32, 33, 34, 35, which are used to fasten the sensor mount 1 to a support part not shown in FIG. 3, in particular, in the interior region of a window of a motor vehicle. With regard to the sensor mount 1, it can be seen from FIG. 3 that in order to form a defined flow limit for the hot-melt adhesive, the base plate 2 also exhibits on its inside which faces the rain sensor 6, which in essence fills out the sensor channel 22 in the illustration according to FIG. 3, a chamfer 36.

It can additionally be seen in the illustration according to FIG. 3 that the locking tongue 21 engages with transversely arranged, projecting end pieces into a locking recess 37, which is made in the transition region between the base plate 2 and the second side wall 4 and into which the locking structure that also exhibits the locking tongue 21 engages, in order to connect the receiving ring 5 with the base plate 2 on this side as well, but in a detachable fashion here.

1. A sensor mount for fastening a sensor (6) to a support part, in which a counter-plate (5) surrounds the sensor (6) and which is equipped with indexing means (18, 19, 20) that interact with the counter-means (14, 15, 30) formed on the sensor (6) for insertion of the sensor (6) into the sensor mount (1) at a correct angle, whereby the sensor mount (1) is produced from sheet metal, characterized in that a base plate (2) is present, on which a side wall (3) is formed, in that the counter-plate (5) is connected with the side wall (3) by means of a one-piece connection so that the base plate (2) and the counter-plate (5) are arranged at a distance from each other, in that the area of the base plate (2) is greater than the area of the counter-plate (5), in that the indexing means (18, 19, 20) are formed on the counter-plate (5), in that an additional side wall (3, 4) [sic] is formed between the base plate (2) and the counter-plate (5), and in that locking structures (21, 37) that can be brought into engagement with each other are formed on the additional side wall (4) and on the counter-plate (5) in order to form a detachable connection between the counter-plate (5) and the additional side wall (4).

2. The sensor mount according to claim 1, characterized in that a retaining strap (7) that goes over the sensor (6) is present, and in that a latching structure (8, 9) for connecting the retaining strap (7) with the counter-plate (5) is formed on the counter-plate (5) and on at least one end of the retaining strap (7).

3. The sensor mount according to claim 1 characterized in that the counter-plate (5) exhibits on its inner edge facing the sensor (6) a chamfer (23) and a cylindrical collar (24) that adjoins the chamfer (23).

4. The sensor mount according to claim 1 characterized in that the indexing means are aligning recesses (18, 19, 20) that are arranged in such a way that the angular distances between at least two alignment recesses (18, 19, 20) are different.

5. The sensor mount according to claim 1 characterized in that the counter-plate is configured in a ring shape as a receiving ring (5).

6. The sensor mount according to claim 1 characterized in that edge recesses (25, 26, 27, 28) are made in the side walls (3, 4).

7. The sensor mount according to claim 1 characterized in that for receiving an additional sensor (17), a resilient retaining tongue (16) is present, which is connected with the base plate (2) in one piece.

8. The sensor mount according to claim 2 characterized in that the counter-plate (5) exhibits on its inner edge facing the sensor (6) a chamfer (23) and a cylindrical collar (24) that adjoins the chamfer (23).

9. The sensor mount according to claim 2 characterized in that the indexing means are aligning recesses (18, 19, 20) that are arranged in such a way that the angular distances between at least two alignment recesses (18, 19, 20) are different.

10. The sensor mount according to claim 3 characterized in that the indexing means are aligning recesses (18, 19, 20) that are arranged in such a way that the angular distances between at least two alignment recesses (18, 19, 20) are different.

11. The sensor mount according to claim 2 characterized in that the counter-plate is configured in a ring shape as a receiving ring (5).

12. The sensor mount according to claim 3 characterized in that the counter-plate is configured in a ring shape as a receiving ring (5).

13. The sensor mount according to claim 4 characterized in that the counter-plate is configured in a ring shape as a receiving ring (5).

14. The sensor mount according to claim 2 characterized in that edge recesses (25, 26, 27, 28) are made in the side walls (3, 4).

15. The sensor mount according to claim 3 characterized in that edge recesses (25, 26, 27, 28) are made in the side walls (3, 4).

16. The sensor mount according to claim 4 characterized in that edge recesses (25, 26, 27, 28) are made in the side walls (3, 4).

17. The sensor mount according to claim 2 characterized in that for receiving an additional sensor (17), a resilient retaining tongue (16) is present, which is connected with the base plate (2) in one piece.

18. The sensor mount according to claim 3 characterized in that for receiving an additional sensor (17), a resilient retaining tongue (16) is present, which is connected with the base plate (2) in one piece.

19. The sensor mount according to claim 4 characterized in that for receiving an additional sensor (17), a resilient retaining tongue (16) is present, which is connected with the base plate (2) in one piece.

20. The sensor mount according to claim 5 characterized in that for receiving an additional sensor (17), a resilient retaining tongue (16) is present, which is connected with the base plate (2) in one piece.
